(19) United States
(12) Patent Application Publication
(10) Pub. No.: US 2004/0257611 A1
(43) Pub. Date: Dec. 23, 2004

(54) Print order receipt unit

(75) Inventor: Eiichi Kito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/814,582

(22) Filed: Apr. 1, 2004

(30) Foreign Application Priority Data
Apr. 1, 2003 (JP) 2003-098156

(51) Int. Cl. G06F 3/12; G06F 15/00; H04N 1/00

(52) U.S. Cl. 358/1.15; 358/1.16; 358/527

(57) ABSTRACT

A print order receipt unit includes a reading device for reading image data of an image recorded on a recording medium, a display, a print order input device for inputting for a print order of the recorded image, a first processing system for displaying the image from the image data read by the reading device on the display and receiving an order instruction from the input device using the displayed image to generate order information, a first memory into which the image data of the image read by the reading device is stored, and a second processing system for storing the read image data into the first memory in parallel with processing by the first processing system. The order information generated by the first processing system and the image data stored into the first memory by the second processing system are related to each other and output.

### BACKGROUND OF THE INVENTION

The present invention relates to the technical field of a print order receipt unit which receives an order of a photographic print (hereinafter simply referred to as a “print”) from an image shot with a digital camera or a camera-equipped mobile phone or an image recorded on a recording medium such as a CD-R by an image digitizing service or the like. More particularly, the invention relates to a print order receipt unit which can promptly start print order operation.

With widespread use of personal computers (PCs) and PDAs (Personal Digital Assistants), more and more digital cameras have been used.

An image shot with a digital camera is typically captured into a PC and used for various applications such as a home page and a New Year card. There is, however, popular demand for storing an image shot with a digital camera as a high-quality (photographic) print.

On the other hand, printing of an image shot on a photographic film such as a negative film or a reversal film (hereinafter referred to as a film) onto photosensitive material (printing paper) generally uses exposure by way of projection of a film image onto photosensitive material, a so-called direct exposure.

In recent years, instead of exposure of photosensitive material by way of projected light from a film, a unit which exposes photosensitive material by way of recording light in accordance with image data obtained by reading the film to prepare a print, a so-called digital photo printer has been placed on the market and is now in growing use.

A digital photo printer reads a film in a photoelectric fashion to obtain the image data of an image shot on a film and convert the image data to digital image data, performs predetermined image processing and conversion to obtain image data for recording, exposes photosensitive material (printing paper) with recording light such as laser beams modulated in accordance with the image data, performs processing of the image, and outputs the processed image as a print. Thus, it is possible to produce a print from an image shot on a film as well as an image (image data) shot with a digital camera.

The digital photo printer offers not only print production service but also the image digitizing service by which digital image data of an image from which a print was produced, or digital image data read from an image of a transparent original (e.g., photographic film) or an image of a reflection original (e.g., photographic print) is recorded on a recording medium such as a CD-R in a predetermined file format and the recording medium on which the digital image data is recorded is provided to a client so that the client can perform reading, displaying, image processing, composition and writing of the image data using his/her PC.

To fulfill the demand for a high-quality print of an image shot with a digital camera and in line with the widespread use of such digital photo printers and diffusion of the image digitizing service, it is a common practice in recent years that a specialized photofinisher such as a print shop or a photolab receives an order for printing or reprinting from an image shot with a digital camera or from an image recorded on a recording medium such as a CD-R and produces prints or reprints.

In case a print order of an image shot with a digital camera is made to a photofinisher, the image data of a shot image is usually stored onto a recording medium including a medium for digital camera such as SmartMedia™ or xD Picture Card™ mounted on a digital camera and the recording medium is delivered to a photofinisher for giving a print order. In the case of printing or reprinting from an image recorded on a recording medium such as a CD-R, the recording medium is delivered to a photofinisher as it is for giving a print order. The photofinisher, receiving the print order, loads the recording medium into a dedicated print order receipt unit (hereinafter referred to as a receipt unit), inputs order information such as frames (images) to be printed and number of prints in accordance with the order, and outputs the image data and the order information such as frames to be printed and number of prints to a digital photo printer.

In addition to the order reception in the storefront by an operator, a client can also make a printing request by loading a recording medium having image data stored thereon into an. (automatic) receipt unit which is installed in the storefront or other places of a print shop, a photolab or a convenience store to enable a general user to operate, and by inputting order information including frames to be printed and number of prints.

On such a receipt unit, as mentioned in JP 11-125867 A or JP 2000-321677 A for example, the image data recorded on a recording medium is read and the image of each frame recorded on the recording medium is shown on a display. Then, order information including frames to be printed and number of prints is input using a keyboard and a mouse as well as a touch-panel display.

The format, number of frames and frames to be printed concerning an image file recorded on a recording medium are initially unknown to the receipt unit. The client who requests printing seldom remembers all of the images recorded on the recording medium. The client generally checks the images displayed on the receipt unit and determines images to be printed.

The receipt unit fetches or downloads all image files recorded on the recording medium into predetermined storage means such as a hard disk, reads out data from the storage means, analyzes the data to recognize the image file format used, then extracts image data and generates images for selection of frames and shows all the images on the display.

Thus, it is impossible to display the image of each frame for order operation until the image file is fetched. As a result, after a recording medium is loaded, it takes time before starting order operation as a primary operation on the receipt unit such as selection of frames to be printed. Especially in recent years, many types of recording medium can record image data of as many as hundreds of frames, so that this tendency is more eminent than ever.

### SUMMARY OF THE INVENTION

In order to solve the prior art problems, the invention aims at providing a print order receipt unit which receives an order of a print or a reprint from an image (image data) shot with a digital camera or from an image recorded on a recording medium such as a CD-R, said print order receipt unit capable of, after loading of a recording medium storing an image shot with a digital camera or a digitized image, promptly executing the primary order operation such as selection of frames to be printed, thereby efficiently performing print order receipt by an operator in a photolab or a print shop and print order receipt by a general user.

In order to attain the object described above, the present invention is to provide a print order receipt unit comprising reading means for reading image data of an image recorded on a recording medium, a display on which the image from the image data read by the reading means is displayed, print order input means for inputting for a print order of the image recorded on the recording medium, a first processing system for displaying the image from the image data read by the reading means on the display and receiving an order instruction from the input means using the displayed image to generate order information, first storage means into which the image data of the image read by the reading means is stored, and a second processing system for storing the image data read by the reading means into the first storage means in parallel with processing by the first processing system, wherein the order information generated by the first processing system and the image data stored into the first storage means by the second processing system are related to each other and output.

In the print order receipt unit of the present invention, it is preferable that the image displayed on the display is a small-sized image or a thumbnail image which conforms to a size of a frame image to be displayed for an operation of an order instruction by the input means so that the first processing system can generate the order information.

Preferably, the first processing system displays a necessary image in accordance with a format of an image file of the image data of the image read by the reading means on the display.

Preferably, the reading means reads only a header of the image file and the first processing system analyzes only the thus read header to determine the format of the image file.

It is also preferable that the first processing system displays on the display a thumbnail image when the image file has the thumbnail image, an image obtained by resizing a non-compressed image data when the image file has the non-compressed image data where the thumbnail image is not recorded, and an image obtained by decompressing and resizing compressed image data when the image file has the compressed image data where the thumbnail image is not recorded.

Preferably, the sized image is a small-sized image or the thumbnail image which conforms to a size of a frame image to be displayed for an operation of an order instruction by the input means so that the first processing system can generate the order information.

It is also preferable that second storage means to store the image displayed on the display is provided in addition to the first storage means to store the image data of the image provided in the second processing system so that the first processing system can generate the order information.

Preferably, the first storage means is external storage means provided separately from a main unit including the reading means, the display, the input means and the first processing system.

Preferably, a printing distribution device including the first storage means and the second processing system is provided separately from a main unit including the reading means, the display, the input means and the first processing system.

Preferably, the printing distribution device further includes image selection means in which an image corresponding to the order information that was generated by the first processing system of a main unit is selected and image data of the selected image is read out from the first storage means.

It is also preferable that plural main units are connected to one printing distribution device or one external storage means.

Preferably, plural digital photo printers are connected to a printing distribution device including at least the second processing system or a main unit including at least the second processing system.

### BRIEF DESCRIPTION OF THE DRAWINGS

FIG. 1 is a block diagram schematically showing an embodiment of a print order receipt unit of the invention;

FIG. 2 is a block diagram showing an exemplary system configuration of the print order receipt unit shown in FIG.

FIG. 3 shows an example of an order screen of the print order receipt unit shown in FIG. 1;

FIG. 4 is a block diagram schematically showing another embodiment of the print order receipt unit of the invention; and

FIG. 5 is a block diagram schematically showing still another embodiment of the print order receipt unit of the invention.

### DETAILED DESCRIPTION OF THE INVENTION

A print order receipt unit of the invention is described below in detail with reference to the preferred embodiments shown in the attached drawings.

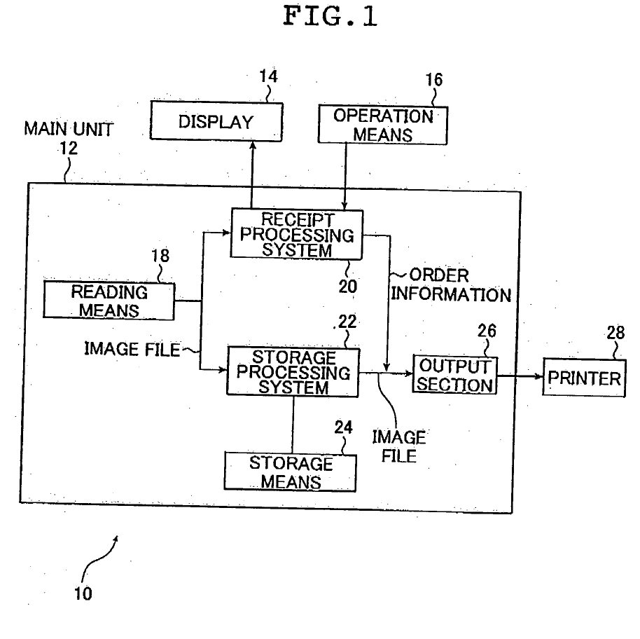

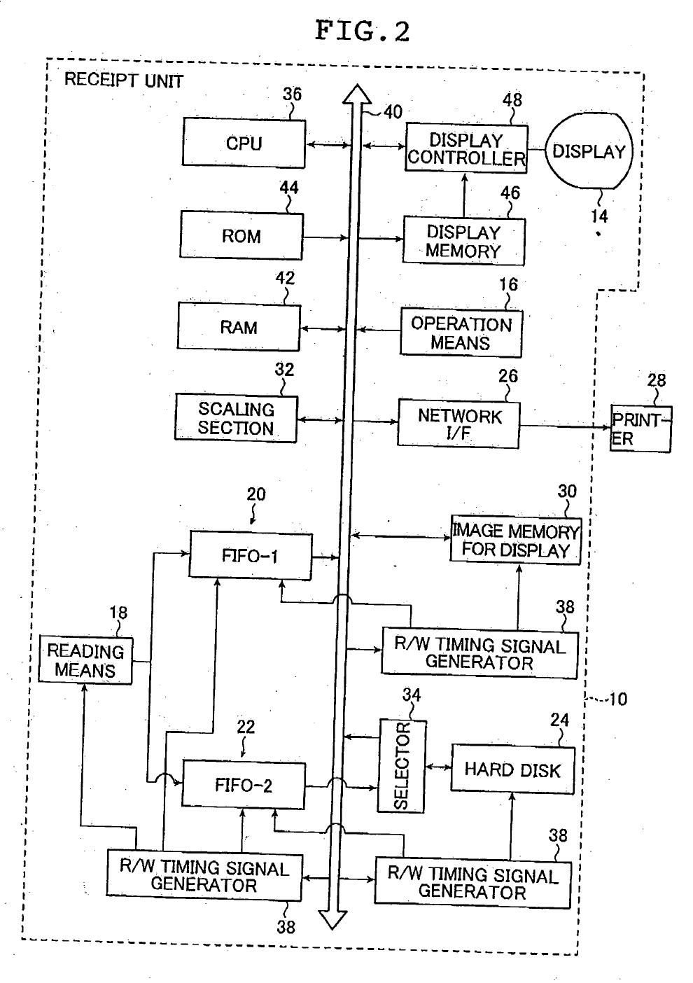

FIG. 1 is a block diagram schematically showing an embodiment of a print order receipt unit according to the invention. FIG. 2 is a block diagram showing an exemplary system configuration of the print order receipt unit shown in FIG. 1.

A print order receipt unit 10 shown in FIGS. 1 and 2 (hereinafter referred to as a “receipt unit”) is for example a unit operated by an operator in a photolab or a print shop (hereinafter collectively referred to as a photolab) in accordance with the print order from a client, or an automatic unit which is installed in the front of a photolab to be operated by a client who orders printing. The print order receipt unit 10 basically comprises a main unit 12, a display 14, and operation means 16.

While not shown, the receipt unit 10 may comprise various components of a well-known print order receipt unit which receives a print order from (digital) image data, such as a slip printer for outputting an order slip indicating the charge and order receipt number.

The receipt unit 10 reads the image file of an image shot with a digital camera or an image recorded by the digitizing service from a recording medium and adds order information including frames to be printed and number of prints to the image file, then outputs the resulting image file to the aforementioned digital photo printer or an image processor (to the printer 28 in the illustrated case).

In the embodiment shown, the display 14 is a well-known display unit and is for example a CRT (Cathode Ray Tube) or an LCD (Liquid Crystal Display). The operation means 16 is well-known operation means such as a mouse and a keyboard.

On the receipt unit 10, various operations are made by way of the GUI (Graphical User Interface) using the display on the display 14 and the operation means 16. The display 14 may be a touch-panel display to include operation means. Touch panel operation on the display 14 and operation with the operation means 16 may be used in combination or selectively.

The main unit 12 basically comprises reading means 18, a receipt processing system 20, a storage processing system 22, storage means (hard disk) 24 and an output section 26.

The reading means 18 reads an image (data) file recorded on a recording medium such as a medium for use in digital camera or a CD-R. There is no particular limitation on the recording medium used in the invention as long as an image file can be recorded. Various types of recording media are available such as media used in digital camera for recording an image shot with a digital camera or a camera-equipped mobile phone (digital image data) as exemplified by SmartMedia™, xD Picture Card™, CompactFlash™, Memory Stick™, SD Media Card™ and Microdrive™ a CD-R (RW) onto which an image (digital image data) is recorded by image digitizing service, an MD, an MO, a flexible disk, and a ZIP™.

The reading means 18 may be well-known means adapted for a recording medium to be used. Means for acquiring an image file from a computer communications network such as the Internet can be used as the reading means 18. The main unit 12 may further comprise a plurality of types of reading means 18.

The receipt processing system 20 corresponds to a first processing system in the invention. The receipt processing system 20 performs order operations on the receipt unit 10 using the display 14 and the operation means 16, such as analysis of an image file read by the reading means 18, generation and display of image data for displaying the image of each frame to be shown on the display 14 for print order, and generation of order information in accordance with print order instruction using the operation means 16.

The storage processing system 22 corresponds to a second processing system in the invention. The storage processing system 22 stores (downloads) the image file-read by the reading means 18 into the storage means 24 (hard disk 24 in the case shown in FIG. 2) of the main unit.

The receipt unit 10, on storing all the image files into the storage means 24 and completing the order operation by the operation means 16, adds order information from the receipt processing system 20 to the image file from the storage processing system 22, or links order information to the image file. In other words, the order information and the image file are related to each other and output from the output section 26 to the aforementioned (digital photo) printer 28.

The receipt unit 10 according to the invention supplies the image file (digital image data) read by the reading means 18 to both the receipt processing system 20 and the storage processing system 22 in parallel for parallel processing by the systems. In other words, the image file is stored into the storage means (hard disk) 24 by the storage processing system 22 while, by the receipt processing system 20 in parallel, the display data of each frame is generated and displayed on the display 14 to receive order operation input using the operation means 16.

This allows the receipt processing system 20 to sequentially analyze/process data and display the image of each frame for order operation without waiting for completion of storage of the image file recorded on a recording medium into the storage means (hard disk) 24. More specifically, when writing an image file into an image memory for display 30, the receipt processing system 20 first reads only the header thereof. Then, the system 20 analyzes the header, determines the format of the image file, and writes the image data in accordance with the determined image file format. The written image data is then stored into the image memory for display 30 as display image data as it is or after having been resized as required in the scaling section 32 so as to conform to the size of a frame image to be displayed for order operation. At the same time, the system 20 displays a small-sized image (thumbnail image) on the order instruction screen of the display 14 to receive an order (inputting of order information) by the operation means 16.

Thus, according to the invention, it is possible to promptly start order operation once a recording medium is loaded, thereby efficiently receiving print orders of an image shot with a digital camera and an image recorded on a medium such as a CD-R.

On the receipt unit 10, as a preferable embodiment, the receipt processing system 20 generates the display data of the image of each frame to be displayed in accordance with the file format of the image file (data file) of digital image data read by the reading means 18.

In case a thumbnail image is recorded in an image file, the receipt processing system 20 writes only the thumbnail image data into the image memory for display 30 as it is as data for displaying on the display 14, and skips reading the remaining data.

In case the image file has a file format of non-compressed image data where thumbnail image is not recorded, the receipt processing system 20 reads the image data of each frame so as to conform to the size of a frame image to be displayed for order operation while thinning out. That is, the image data is resized to obtain display data of, for example, a small-sized image (thumbnail image) which is compatible with display on the display 14.

In case the image file has a file format of compressed image data where thumbnail image is not recorded, the receipt processing system 20 writes the compressed image data of each frame into the image memory for display 30, then decompresses and resizes the data in the scaling section 32 so as to conform to the size of a frame image to be displayed for order operation, thereby obtaining display data of, for example, a small-sized image. (thumbnail image) which is compatible with display on the display 14.

The image file (image file format) of image data of an image shot with a digital camera or an image recorded on a medium such as a CD-R is typically Exif. The image data generated by a digital camera includes, for example, RGB non-compressed data, YCbCr non-compressed data and JPEG compressed data. The file format of Exif is determined in accordance with the type of image data.

Thus, the file format of an image file can be determined through analysis of the header of the image file.

A thumbnail image can be recorded in any file format and its presence/absence can be determined through analysis of the image file and in particular the header.

For example, in an image file of non-compressed data, in case a thumbnail image is not recorded, offset of Next IFD at the 0th IFD indicating the first address of the 1st IFD (Image File Directory) corresponding to a thumbnail image terminates at 00000000.H, which can be used to determine whether a thumbnail image is present. In an image file of compressed data, a thumbnail image can be recorded at the 1st IFD of the application marker segment 1 (APP1) which records additional Exif information. Thus the information recorded in the APP1 can be analyzed to determine whether a thumbnail image is present.

The operation of the receipt unit 10 shown in FIG. 1 is described below with reference to an exemplary system configuration of the receipt unit 10 shown in FIG. 2 in order to further detail the print order receipt unit according to the invention.

In FIG. 2, a selector 34 switches between data input and data output to/from the hard disk 24. Data read operation by the reading means 18 and switchover of between data input and output in the FIFO-1 and FIFO-2, selector 34, image memory for display 30 and hard disk 24 are made in accordance with a signal coming from an R/W timing signal generator 38 in response to an instruction from a CPU 36.

When a recording medium is loaded into the reading means 18, the reading means 18 starts reading an image file and supplies in parallel the read image file to the FIFO-1 (memory) corresponding to the receipt processing system 20 and the FIFO-2 (memory) corresponding to the storage processing system 22.

In the storage processing system 22, the FIFO-2 which has received data uses the FIFO (first-in, first-out) method to sequentially store and output the image file data items and transmit the image file from the selector to the hard disk for example by way of DMA (Direct memory Access) transfer in order to store all the image files.

As mentioned earlier, the image file read by the reading means 18 is supplied to the FIFO-2 as well as FIFO-1- and in parallel with storage of the image file into the hard disk 24 by the storage processing system 22, the following processing is performed.

The FIFO-1, receiving data, similarly uses the FIFO method to store the image file and output it to a bus line. 40, and a RAM 42 stores the image file.

When the RAM 42 stores the image file, the CPU 36 reads the file and starts to analyze it. The CPU 36 analyzes the header of the image file, identifies the file format of the image file to determine the type of image data (compressed data or non-compressed data), and further determines whether a thumbnail image is recorded. Note that the ROM 44 stores various programs, data and parameters for an order instruction made in the CPU 36.

In case the thumbnail image is recorded, the CPU skips reading the other data and extracts only the thumbnail image data. The CPU then reads the thumbnail image data as display (image) data from the RAM 42 and stores the read data into the image memory for display 30.

In case the thumbnail image is not recorded in the image file and the image data is non-compressed data, the CPU 36 extracts and reads out the image data (through thinning-out) from the RAM 42, and stores the read image data into the image memory for display 30. The image data that the CPU 36 read out from the RAM 42′ may be resized in the scaling section 32 and stored into the image memory for display 30.

In case the thumbnail image is not recorded in the image file and the image data is compressed data, the CPU 36 reads the compressed data out from the RAM 42, decompresses the read compressed data, extracts the decompressed data (through thinning-out) and stores the extracted decompressed data into the image memory for display 30. The CPU 36 may read out the compressed data from the RAM 42, decompress the data, resizes the decompressed data in the scaling section 32, and stores the resized data into the image memory for display 30.

In case the image file does not have a thumbnail image, image data may be stored into the image memory for display 30 while thinning out the image data.

After the display data is stored into the image memory for display 30, the. CPU 36 sequentially reads out the data frame by frame and, if necessary, resizes (performs electronic magnification of) the data in the scaling section 32, and stores the resized data as data adapted for display image into a display memory 46.

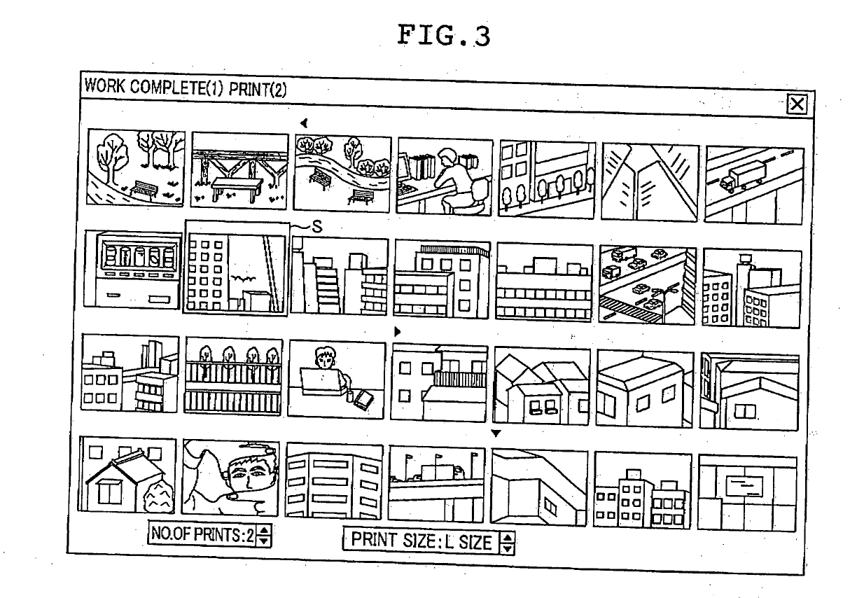

When the display memory 46 has stored display data for a predetermined number of frames, a display controller 48 shows an order operation screen on the display 14 as well as reads out the display data of each frame from the display memory 46, converts the data to image data compatible with the representation on the display, and shows the image of each frame in a predetermined position of the order operation screen shown on the display 14. FIG. 3 shows an example of order operation screen (Frame S indicates a selected frame).

When the display 14 shows the order operation screen and the image of each frame, an operator (a client who orders printing or an operator in a photolab) starts print order operation using the operation means 16 to input order information including frames to be printed, number of prints per frame and print size. These operations may be made by way of the GUI using the display on the display 14 and the operation means 16 as mentioned earlier, for example as in well-known print order receipt units.

The CPU 36 generates order information including information necessary for printing in accordance with print order such as the frames in an image file to be printed, number of prints per frame and print size of each frame, and stores the information into the RAM 42.

As mentioned earlier, the data read by the reading means 18 is supplied to the FIFO-1 and FIFO-2 in parallel. Operation including storage/output of an image file by the FIFO-1, analysis by the CPU, image display of each frame, and generation of order information in accordance with input instruction, that is, operation by the receipt processing system 20, and storage of an image file stored/output by the FIFO-2 into the hard disk 24, that is, operation by the storage processing system 22, proceed in parallel.

When all the image files have been stored into the hard disk 24 and an instruction to complete the order operation is input using the operation means 16, the CPU 36 reads out the image files from the hard disk 24 and order information from the RAM 42 and adds or links order information to each image file, then outputs the file to the (digital photo) printer 28 via the network interface I/F (output section) 26.

The print order receipt unit of the invention is basically configured as described above.

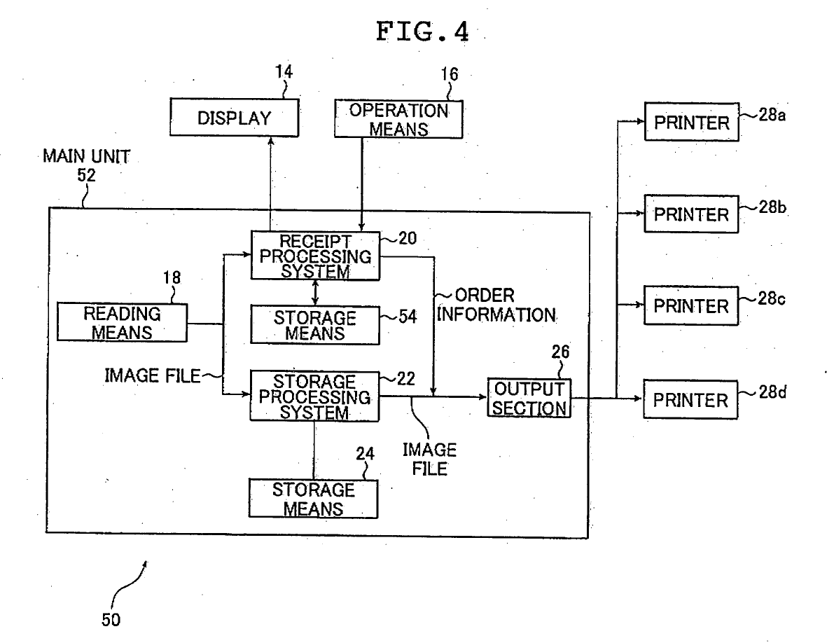

Next, FIG. 4 is a block diagram schematically showing another embodiment of the print order receipt unit of the invention.

A print order receipt unit 50 shown in FIG. 4 has basically the same configuration as that of the print order receipt unit 10 shown in FIG. 1 except that a receipt processing system 20 of the unit 50 is provided with storage means 54 and four printers 28a, 28b, 28c and 28d are connected to a main unit 52. Therefore, like components are identified by like numerals and their description will be omitted.

The receipt unit 50 shown in FIG. 4 basically comprises the main unit 52, a display 14 and operation means 16. The four printers 28a, 28b, 28c and 28d are connected to the main unit 52.

The main unit 52 basically comprises reading means 18, a receipt processing system 20, a storage processing system 22, storage means (hard disk) 24, an output section 26, and the storage means 54.

The storage means 54 is connected to the receipt processing system 20 and is used to store small-sized images for use in receipt processing, for example a thumbnail image.

In this embodiment, even if image data of an image to be ordered and its order information (order data) are transmitted from the receipt processing system 20 to one of the printers 28a, 28b, 28c and 28d, image data of a small-sized image (thumbnail image) in the receipt processing system 20 is stored in the storage means 54 and is by no means erased. Therefore, an instruction for an additional order is possible. To be more specific, since a small-sized image (thumbnail image) is stored in the storage means 54 of the receipt unit 50 according to this embodiment, the operation means 16 is used to fetch a small-sized image from the storage means 54 to the receipt processing system 20 and display the small-sized image on the display 14 again so that an instruction can be made for a new additional order.

For example, when an operator in a photolab receives an order from a client through the operation of the receipt unit 50 while talking with the client, if the client desires print order processing in a rapid mode, high speed printing is performed by using a high speed printer or selecting a high speed mode (rapid processing mode) in a printer used. Thus, the client can receive a finished print in a few minutes.

In this case, the operator first receives in the receipt unit 50 a general print order for printing in an ordinary size and issues a print instruction in a high speed mode to the printer 28a for use in ordinary printing. Then, since it takes several minutes to output a finished print of an ordinary size, the operator can make use of the time required for finishing to recommend a value-added print to the client while displaying on the display 14 a thumbnail image fetched from the storage means 54 by means of the receipt unit 50 and also showing to the client value added print samples such as an enlarged print, a calendar print and a frame print. In this case, the printers 28b, 28c and 28d can be used for printing value-added prints.

As understood from the above description, the receipt units 10 and 50 according to the invention can record (download) an image file and perform processing for order operation as well as order operation in parallel. Thus it is possible, after loading a recording medium, to promptly start order operation without waiting for completion of storage of an image file recorded on the recording medium into a hard disk, thereby efficiently receiving a print order of images shot with a digital camera.

On the above-mentioned receipt units 10 and 50 of the invention, frame images may be shown sequentially in the order screen on the display 14 from those frames which can be displayed, in accordance with the progress in the storage of display data into a display memory. Or, a predetermined number of frames may be shown at a stroke once the frames area ready for display.

The number of frames shown on a single screen of the display is not particularly limited but all the frames recorded in an image file may be displayed in one screen. Or, frames may be shown as required in units of a preset number of frames in a screen, for example 10 frames or 20 frames may be displayed.

The total number of image data items (total number of frames) recorded into an image file can be typically recognized through analysis of the header. By taking advantage of this approach, the total number of frames may be shown on the display 14 once the total number of frames of an image file is recognized and the operator may select the number of frames to be shown on a single screen. Or, the CPU may automatically determine the number of frames to be displayed on a screen.

When the number of frames shown on an order screen is changed as required, the size of each frame may be automatically changed in accordance with the number of frames shown.

In case all the frames of an image file are not shown on a singer screen of the display, all the frames may be checked through scrolling or page switching.

While a hard disk is used as the storage means 24 for storing an image file in the foregoing embodiments, the invention is not limited thereto but a memory such as a nonvolatile memory (e.g., flash memory) or a volatile memory (e.g., DRAM) may be used as the storage means as long as the memory has sufficient storage capacity.

The storage means 24 for storing an image file read by the reading means 18 is not limited to the storage means built into the receipt units 10 and 50 but external storage means connected to the main unit may be used. Or, the storage means as a component of an image processor of a digital photo printer may be used to store an image file as the storage means in the invention.

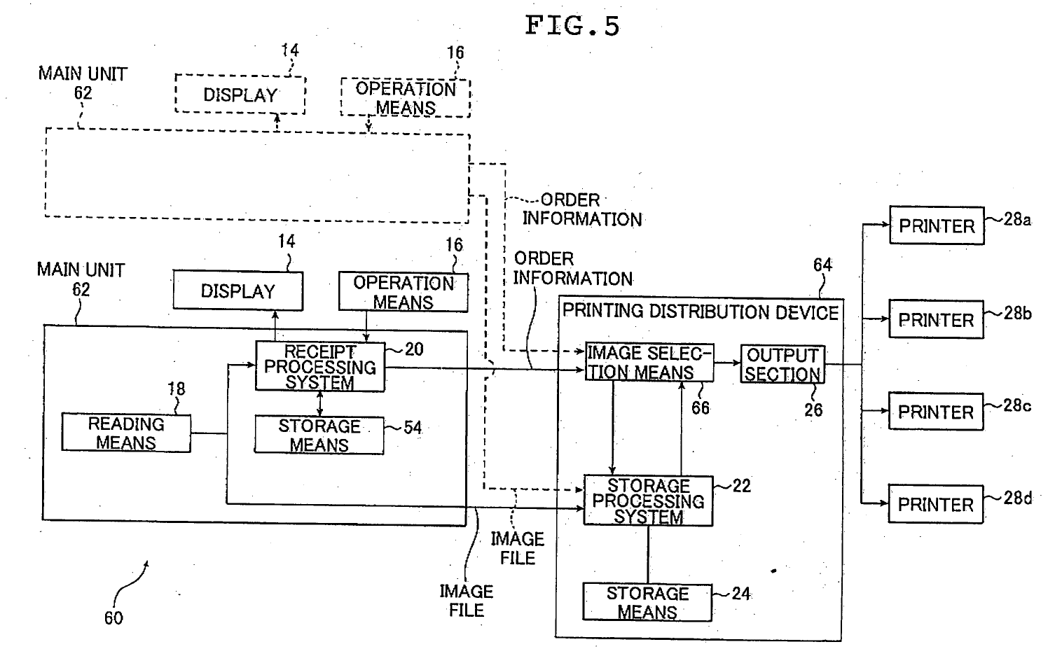

FIG. 5 is a block diagram schematically showing still another embodiment of the print order receipt unit of the invention which has external storage means connected to the main unit.

A print order receipt unit 60 shown in FIG. 5 has basically the same configuration as that of the print order receipt unit 50 shown in FIG. 4 except that the functions of the storage processing system 22 and the storage means 24 in the main unit 52 are made independent and that a printing distribution device is provided separately from a main unit 62. Therefore, like components are identified by like numerals and their description will be omitted.

The receipt unit 60 shown in FIG. 5 basically comprises the main unit 62, the printing distribution device 64, a display 14 and operation means 16. To the printing distribution device 64 are connected four printers 28a, 28b, 28c and 28d.

The main unit 62 basically comprises reading means 18, a receipt processing system 20 and storage means 54.

Further, the printing distribution device 64 includes a storage processing system 22, image selection means 66, storage means (hard disk) 24 and an output section 26. Image data of an image file read from a recording medium by the reading means 18 is stored into the storage means 24 via the storage processing system 22, and the image selection means 66 reads out from the storage means 24 image data of an image corresponding to order information generated in the receipt processing system 20 based on the order received in the main unit 62. The image data and the order information are related to each other and then output from the output section 26 to one of the printers 28a-28d.

In addition to the effect achieved by the receipt unit 50 shown in FIG. 4, the receipt unit 60 has additional effects of downsizing of the main unit 62 due to exclusion of the storage means 24 from the main unit 62 and cost reduction.

Since it is possible to externally provide the storage means 24 in this embodiment, another main unit 62 can be connected to the printing distribution device 64 particularly as shown by dotted lines in FIG. 5. As a result, plural main units 62 can be connected to one printing distribution device 64 and used, which may lead to the cost reduction of the receipt unit as a whole.

While the print order receipt system according to the invention has been detailed hereinabove with reference to various embodiments, the invention is not limited to the above embodiments but various improvements or modifications may be made without departing from the spirit of the invention.

As detailed hereinabove, a print order receipt unit according to the invention can promptly start order operation, after loading of a recording medium, thereby efficiently performing order receipt of an image shot with a digital camera.

What is claimed is:

1. A print order receipt unit comprising:
reading means for reading image data of an image recorded on a recording medium;
a display on which said image from said image data read by said reading means is displayed;
print order input means for inputting for a print order of said image recorded on the recording medium;
a first processing system for displaying said image from said image data read by said reading means on said display and receiving an order instruction from said input means using said displayed image to generate order information;
first storage means into which said image data of said image read by said reading means is stored; and
a second processing system for storing said image data read by said reading means into said first storage means in parallel with processing by said first processing system,
wherein said order information generated by said first processing system and said image data stored into said first storage means by said second processing system are related to each other and output.

2. The print order receipt unit according to claim 1, wherein said image displayed on said display is a small-sized image or a thumbnail image which conforms to a size of a frame image to be displayed for an operation of an order instruction by said input means so that said first processing system can generate said order information.

3. The print order receipt unit according to claim 1, wherein said first processing system displays a necessary image in accordance with a format of an image file of the image data of said image read by said reading means on said display.

4. The print order receipt unit according to claim 3, wherein said reading means reads only a header of said image file and said first processing system analyzes only the thus read header to determine said format of said image file.

5. The print order receipt unit according to claim 3, wherein said first processing system displays on said display a thumbnail image when said image file has said thumbnail image, an image obtained by resizing a non-compressed image data when said image file has said non-compressed image data where the thumbnail image is not recorded, and an image obtained by decompressing and resizing compressed image data when said image file has said compressed image data where the thumbnail image is not recorded.

6. The print order receipt unit according to claim 5, wherein the resized image is a small-sized image or the thumbnail image which conforms to a size of a frame image to be displayed for an operation of an order instruction by said input means so that said first processing system can generate said order information.

7. The print order receipt unit according to claim 1, wherein second storage means to store the image displayed on said display is provided in addition to said first storage means to store the image data of said image provided in said second processing system so that said first processing system can generate the order information.

8. The print order receipt unit according to claim 1, wherein said first storage means is external storage means provided separately from a main unit including said reading means, said display, said input means and said first processing system.

9. The print order receipt unit according to claim 1, wherein a printing distribution device including said first storage means and said second processing system is provided separately from a main unit including said reading means, said display, said input means and said first processing system.

10. The print order receipt unit according to claim 9, wherein said printing distribution device further includes image selection means in which an image corresponding to said order information that was generated by said first processing system of a main unit is selected and image data of the selected image is read out from said first storage means.

11. The print order receipt unit according to claim 9, wherein plural main units are connected to one printing distribution device.

12. The print order receipt unit according to claim 9, wherein plural digital photo printers are connected to a printing distribution device including at least said second processing system.

13. The print order receipt unit according to claim 8, wherein plural main units are connected to one external storage means.

14. The print order receipt unit according to claim 1, wherein plural digital photo printers are connected to a main unit including at least said second processing system.
